(19) United States
(12) Patent Application Publication
(10) Pub. No.: US 2023/0173951 A1
(43) Pub. Date: Jun. 8, 2023

(54) METHOD FOR OPERATING A FUEL CELL SYSTEM, COMPUTER PROGRAMME PRODUCT AND FUEL CELL SYSTEM INTEGRATED IN A MOTOR VEHICLE

(71) Applicant: MAHLE International GmbH, Stuttgart (DE)

(72) Inventor: Richard Bruemmer, Stuttgart (DE)

(21) Appl. No.: 18/077,587

(22) Filed: Dec. 8, 2022

(30) Foreign Application Priority Data
Dec. 8, 2021 (DE) 10 2021 213 977.9

(51) Int. Cl. B60L 58/40; B60L 50/75; B60W 10/26; B60W 30/188

(52) U.S. Cl. CPC B60L 58/40; B60L 50/75; B60W 10/26; B60W 30/188

(57) ABSTRACT

A method for operating a fuel cell system may include at least one fuel cell, at least one rechargeable traction battery, at least one traction drive, and a power management device. The power management device may be electrically coupled to the at least one fuel cell, the at least one traction battery, and the at least one traction drive. The method may include providing electric primary power via the at least one fuel cell. The method may also include providing electric secondary power via the at least one traction battery. The at least one fuel cell may be profile-controlled.

### CROSS-REFERENCE TO RELATED APPLICATIONS

This application claims priority to German Patent Application No. DE 10 2021 213 977.9, filed on Dec. 8, 2021, the contents of which is hereby incorporated by reference in its entirety.

### TECHNICAL FIELD

The invention relates to a method for operating a fuel cell system. In addition, the invention relates to a computer programme product and to a fuel cell system integrated in a motor vehicle.

### BACKGROUND

A generic method is known from DE 10 2017 007 633 A1, according to which for operating a fuel cell of a motor vehicle it is provided to satisfy a specified requirement of drive power of a traction drive of the motor vehicle primarily by primary power, which is provided by a fuel cell of the motor vehicle. Because of the chemical operation of the fuel cell, providing the primary power however is relatively sluggish and lags the actual requirement of drive power, so that a power differential between the provided primary power and the specified requirement of drive power, which in practice is also referred to as power jump, has to be covered by additional power. This additional power referred to as secondary power is provided by a rechargeable traction battery of the motor vehicle. In order to prevent unfavourable operating ranges of the fuel cell caused by load peaks, DE 10 2017 007 633 A1 proposes to complement the dependency of the provision of primary power on the required drive power by a variable damping. By way of this, severe sudden changes of the required drive power can merely affect the provision of primary power or the operation of the fuel cell in a dampened manner. Disadvantageous in this actually elegant solution is that a delay in the response time of the fuel cell results in particular operating situations of the motor vehicle, for example start-up situations or emergency braking situations, a delay in the response time of the fuel cell results, which is not desirable in particular in these special operating situations of the motor vehicle.

### SUMMARY

The object of the invention lies in stating for a method for operating a fuel cell system an embodiment that is improved or at least different compared with the state of the art.

In the present invention, this object is solved through the subject matter of the independent claim(s). Advantageous embodiments are the subject matter of the dependent claim(s) and of the description.

The basic idea of the invention lies in operating the at least one fuel cell in a specified, energy-efficient operating range.

To this end, the invention proposes a method for operating a fuel cell system, with which the fuel cell system is provided at least with a fuel cell generating electric primary power, at least one rechargeable traction battery providing an electric secondary power, at least one traction drive and a power management device with which the at least one fuel cell, the at least one traction battery and the at least one traction drive are electrically coupled. It is substantial that the at least one fuel cell is profile-controlled.

This has the effect that the at least one fuel cell generates and provides electric primary power in a profile-controlled manner. In the process, the profile control can practically be dependent on the charge status of the battery. Further practically, the profile control can be varied or adapted as a function of the charge status of the traction battery. Further practically, the profile control can be varied or shifted as a function of the charge status of the traction battery so that the fuel cell either provides a relatively high amount of primary power, as a result of which a charge status of the at least one traction battery raised with respect to a mean charge status of the at least one traction battery is achieved, or provides a relatively low amount of primary power, as a result of which a charge status of the at least one traction battery that is lowered with respect to a mean charge status of the at least one traction battery is achieved. This has the advantage that undesirable operating ranges of the fuel cell, for example load peaks, are largely avoided. This has the positive effect that the at least one fuel cell consumes relatively few consumables. Further, it generates a constant lost heat flow free of load peaks which in terms of cooling, can be comparatively easily controlled and for example dissipated by means of a cooling system of the fuel cell system employed for cooling the at least one fuel cell.

Practically, the at least one fuel cell is profile-controlled dependent on a drive power and/or as a function of a charge status of the at least one traction battery. The operation of the at least one fuel cell or the provision of primary power can thus be coupled to a specified drive power to be provided by at least one traction drive and/or to a charge status of the at least one traction battery. Because of this, the at least one fuel cell can be operated so that an acceptable power jump results, i.e. an acceptable amount of secondary power has to be provided. This has the advantage that a desired target charge status of the traction battery can be achieved and/or maintained. Further, it can be operated in an energy-efficient operating range, in particular in a mean power range with optimal efficiency.

Practically, the invention interprets the term “profile-controlled” or “profile control” in a relatively wide sense, namely both in the sense of an open loop control and also in the sense of a closed loop control. Accordingly, profile-controlled can either mean an open loop profile control or a closed loop profile control.

Further practically it can be provided that the at least one fuel cell is profile-controlled so that it provides electric primary power as a function of a fuel cell profile referred to as FCBK in the following. Practically, the FCBK describes the functional relationship between the requirement of drive power and the primary power and/or secondary power to be provided by the fuel cell system for this purpose. The FCBK is practically dependent on a drive power and/or dependent on a charge status of the at least one traction battery. The FCBK is practically realised through a linear function or a non-linear function or a series of interpolable support points. The FCBK has practically a positive slope at least in portions, so that for small drive powers to be provided by at least one traction drive, small amounts of electric primary power and for growing drive powers to be provided, likewise growing larger amounts of electric primary power are generated and provided. Practically, the FCBK has a slope of zero at least in portions, so that in a diagram, in which drive powers to be provided are plotted over the provided primary powers, it forms a horizontal at least in portions.

Furthermore it can be provided that electric drive power, which is requested out of a power range extending from a no-load power to a full-load power of the at least one traction drive, is at least proportionally provided by the provided electric primary power. Here, a power differential (power jump) between the requested electric drive power and the provided electric primary power can be provided by electric secondary power, so that the requested electric drive power in total is composed of electric primary power and/or of electric secondary power. Because of this, at least one amount of the power required for providing the requested drive power is supplied by the at least one traction battery. By way of this, a certain relief of the at least one fuel cell and its cooling can be achieved. By way of the FCBK or the profile control of the at least one fuel cell, each requested drive power out of the said power range is assigned a specified composition ratio of electric primary power to electric secondary power. By way of this, the at least one fuel cell can be relatively easily operated within preferred operating ranges, so that in particular power peaks and excessively high operating temperatures accompanied by this can be avoided on the at least one fuel cell.

Furthermore, the primary power generated by the at least one fuel cell can be provided on the power management device and by means of the same, distributed to suit requirement to the at least one traction drive for providing a drive power and/or to the at least one traction battery for recharging the same. Optionally it can be provided that the profile control of the at least one fuel cell is carried out by the power management device. This means that the power management device carries out an open loop control or a closed loop control of the at least one fuel cell.

It is practical, furthermore, when the FCBK in a first power section of the said power range is provided by a straight line with constant, specifiable slope and with specifiable zero point offset. Because of this, the at least one fuel cell can be controlled within the first power section dependent on a drive power in such a manner that it provides electric primary power which is composed of a constant basic amount of primary power of electric primary power specified by the zero point offset and of an additional amount of primary power for growing drive powers to be provided likewise growing proportionally according to the specified slope of the straight line. Here, the said slope of the straight line can be positive so that the FCBK constantly increases over the said first power section which if applicable extends completely from a no-load power of the traction drive up to a full-load power of the traction drive. It is also conceivable that the said slope of the straight line is zero, in a pure range extender operation, i.e. the primary power provided by the fuel cell is dependent only on the charge status of the at least one traction battery, not on the requested drive power. In summary, constant electric primary powers likewise growing or a range extender operation can thus be provided within the first power section for growing, requested electric drive powers. Although for relatively high drive powers to be provided the amount of the drive power to be provided increases by way of this, which drive power is provided by electric primary power, but not to the same extent as the drive powers. By way of this, the amount to be provided by electric secondary power increases or diminishes at the same time. Conversely, the amount of the drive power to be provided for relatively low drive powers to be provided, which is provided by electric primary power, decreases, however likewise to a lesser extent than the drive power. By way of this, the amount to be provided by electric secondary power decreases. Because of this, the at least one fuel cell can be saved and operated in preferred operating ranges even with relatively low drive powers to be provided. For example, with relatively low drive powers to be provided (including no-load power), the at least one fuel cell can generate a certain base of electric primary power, which can be utilised for example for charging the at least one traction battery.

The said power range of at least one traction drive extends from a no-load power to a full-load power, in other words, it constitutes the power capacity of a traction drive. It can be practically standardised to a value range between 0 and 1 (0% and 100%). Additionally considering recuperation as well, the value range expands to negative values. What has been said can also be extrapolated into the negative range in this case. For example, the fuel cell can be continued to be operated with reduced power with increasing recuperation operation, as a result of which the traction battery on the one hand is charged by the power provided by the recuperation and on the other hand by the primary power provided by the fuel cell.

In other words, the said basic amount of primary power practically describes a base of electric primary power which is generated and provided by the at least one fuel cell in particular in the no-load mode. It can be specified by the said zero point offset, i.e. again in other words, by a shift of the FCBK, so that the at least one fuel cell generates and provides more or less electric primary power. The said additional amount of primary power is practically a variable amount of the electric primary power dependent on power and/or on a charge status of the at least one traction battery. Basic amount of primary power and additional amount of primary power together can form the electric primary power generated and provided by the at least one fuel cell in total.

Further it is practical when the first power section extends over the power range completely or at least in portions. Alternatively it can be provided that the first power section extends above a first specified power threshold and/or below a second specified power threshold. Here it can be useful when the first power threshold is variably adjustable over the entire power section; optionally it amounts to 30% of the full-load power. Further, the second power threshold can also be variably adjustable over the entire power section, and optionally it corresponds to 70% of the full-load power. It is obvious that values deviating upwards or downwards can also be selected. However, the second power threshold is practically always greater or equal to the first power threshold. Furthermore, the electric primary power can be provided with a basic amount of primary power of zero or greater than zero. By way of this, preferred ranges for the first power section are stated.

In order to be able to generate and provide adequate electric primary power and if applicable excess power for recharging the at least one traction battery by means of the at least one fuel cell, it can be provided, furthermore, that the specified basic amount of primary power is dependent on a charge status of the at least one traction battery. Alternatively or additionally it can be provided that a charge status of the at least one traction battery, raised with respect to the said charge status of the at least one traction battery, is achieved by increasing the specified basic amount of primary power. Conversely, it can also be provided that a charge status of the at least one traction battery that is lowered with respect to the said charge status of the at least one traction battery is achieved by reducing the specified basic amount of primary power.

Furthermore, the at least one fuel cell can be profile-controlled by means of the FCBK dependent on a drive power and/or dependent on a charge status of the at least one traction battery so that, in the event that the at least one traction drive is operated with a no-load power, it generates and provides a specified base of electric primary power referred to as basic amount of primary power deviating from zero. By way of this, the at least one fuel cell is then operated in a preferred operating range even when the at least one traction drive is in the no-load mode or switched off and the requested electric drive power is thus practically zero or zero. In other words, the fuel cell, by way of this, is operated with a basic utilisation, in the case of which a certain measure of electric primary power is provided permanently or for as long as the fuel cell system is active. Initially this has the advantage that even with the at least one traction drive at no-load, a certain base of accessible primary power is available, so that for example in a particular operating situation of a motor vehicle, for example a start-up situation, merely the remaining power differential has to be covered by electric secondary power. This results in a noticeable (measurable) relief of the at least one traction battery. Furthermore, the electric primary power (basic amount of primary power) generated with the at least one traction drive at no-load can be utilised for example for recharging the at least one traction battery, so that a specified charge status of the same can be retained.

In order to be able to depict different load statuses of the at least one traction battery, it can be practical when the specified basic amount of primary power is dependent on a specified (mean) load status of the at least one traction battery and/or on a differential of different load statuses of the at least one traction battery. In the process, a load status of the at least one traction battery, raised with respect to the specified (mean) load status of the at least one traction battery, can be achieved by increasing the specified basic amount of primary power. Conversely, a load status of the at least one traction battery lowered with respect to the specified (mean) load status of the at least one traction battery can be achieved by reducing the specified basic amount of primary power.

It is practical, further, when the FCBK, in a second power section of the said power range extending below a or the said first power threshold has the value zero or substantially the value zero. By way of this, the at least one fuel cell can be profile-controlled within the second power section so that it does not generate and provide any or practically no electric primary power. In the process, the first power threshold value can be variably adjustable over the entire power section; optionally it amounts to 30% of the full load power. This describes a capping range, within which the at least one fuel cell provides a constant amount (here zero or practically zero) of electric primary power, the same quasi independently of the actually requested drive power.

It is also practical when the FCBK has a constant maximum value in a third power section of the said power range extending above a second power threshold value. By way of this, the at least one fuel cell can be profile-controlled within the third power section so that it provides a maximally providable amount of primary power of electric primary power. In the process, the second power threshold value can be preferably variably adjustable over the entire power section, but optionally corresponds to 70% of the full load power of the at least one traction drive. This describes a further capping range within which the at least one fuel cell provides a constant amount (here greater than zero, preferably 100% of the electric primary power that can be provided by the at least one fuel cell) of electric primary power, and this quasi regardless of the actually requested drive power.

Furthermore it can be provided that the FCBK is dependent on a load status of the at least one traction battery. By way of this, electric primary power can be provided dependent on the battery charge status. Alternatively or additionally, the FCBK can be dependent on an ambient temperature of the fuel cell system, so that electric primary power is also provided dependent on temperature. Further alternatively or additionally, the FCBK can also be dependent on a battery production age of at least one traction battery, so that dependent on the battery status electric primary power is provided. Further, it can be alternatively or additionally provided that the FCBK is dependent on a battery charge cycle number of at least one traction battery, so that dependent on the battery status electric primary power is provided. It can also be practical when the FCBK is alternatively or additionally dependent on a fuel cell coolant temperature of at least one fuel cell, so that dependent on the fuel cell status electric primary power is provided. Further it is conceivable that the FCBK is alternatively or additionally dependent on a battery coolant temperature of at least one traction battery, so that dependent on the battery status electric primary power is provided. By way of this, the profile control of the at least one fuel cell is dependent on further variables relevant to the fuel cell system, so that the operation of the fuel cell can also take into account these variables.

Practically it can be provided that the traction battery is charged by means of the electric primary power provided by at least one fuel cell in the case that the requested drive power is smaller in the amount than the electric primary power provided by the fuel cell at this time. By way of this, the at least one traction battery can be recharged again in the case of an excess of electric primary power generated by the at least one fuel cell which is conceivable for example upon a sudden load change on at least one traction drive.

A further basic idea that can be realised additionally or alternatively to the above basic idea lies in stating a computer programme product which, when the programme or programme product is executed by a computer or a vehicle computer of a motor vehicle, in particular a power management device, prompts the same to carry out the method described above. Such a computer programme product can be implemented for example in a power management device of a fuel cell system in order to carry out the method described above in a fuel cell system. Practically, the computer programme product can also be implemented in a vehicle computer of a motor vehicle, which can practically form a part of a power management device of a fuel cell system of a motor vehicle.

Another further basic idea that can be realised additionally or alternatively to the above basic ideas lies in stating a fuel cell system integrated in a motor vehicle which is equipped at least with a rechargeable traction battery providing electric secondary power, at least one traction drive and a power management device with which the at least one fuel cell, the at least one traction battery and the at least one traction drive is electrically coupled. The said power management device is practically equipped in order to execute the computer programme product described above and/or carry out the method described above. By way of this, a preferred implementation of the method described above in a power management device of a fuel cell system of a motor vehicle is stated. Hence, the motor vehicle is quasi equipped in order to use the above method.

In summary it remains to note: the present invention preferentially relates to a method for operating a fuel cell system, in the case of which the fuel cell system is provided with a fuel cell generating electric primary power, at least one rechargeable traction battery providing electric secondary power, at least one traction drive and a power management device, with which the at least one fuel cell, the at least one traction battery and the at least one traction drive are electrically coupled, the at least one fuel cell being profile-controlled. In addition, the invention practically relates to a computer programme product comprising commands, which, when the programme is executed by a computer or a vehicle computer of a motor vehicle, causes the same to carry out the above method. In addition, the invention further practically relates to a fuel cell system integrated in a motor vehicle for carrying out the above method.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically:

FIG. 1 shows a highly simplified block diagram of a fuel cell system according to the invention in accordance with a preferred exemplary embodiment,

FIG. 2 shows a diagram for representing an FCBK, wherein the abscissa shows an electric drive power standardised to a value range between 0 and 1 (0% and 100%) of electric drive power within a power range of a traction drive and the ordinate an electric primary power of at least one fuel cell standardised to a value range between 0 and 1 (0% and 100%),

FIG. 3 shows a further diagram for representing modified FCBKs, wherein the abscissa shows a drive power standardised to a value range between 0 and 1 (0% and 100%) within a power range of a traction drive and the ordinate an electric power of at least one fuel cell standardised to a value range between 0 and 1 (0% and 100%),

FIGS. 4 to 6 show a diagram each for representing the electric primary powers and electric secondary powers over the time provided with different power curves.

### DETAILED DESCRIPTION

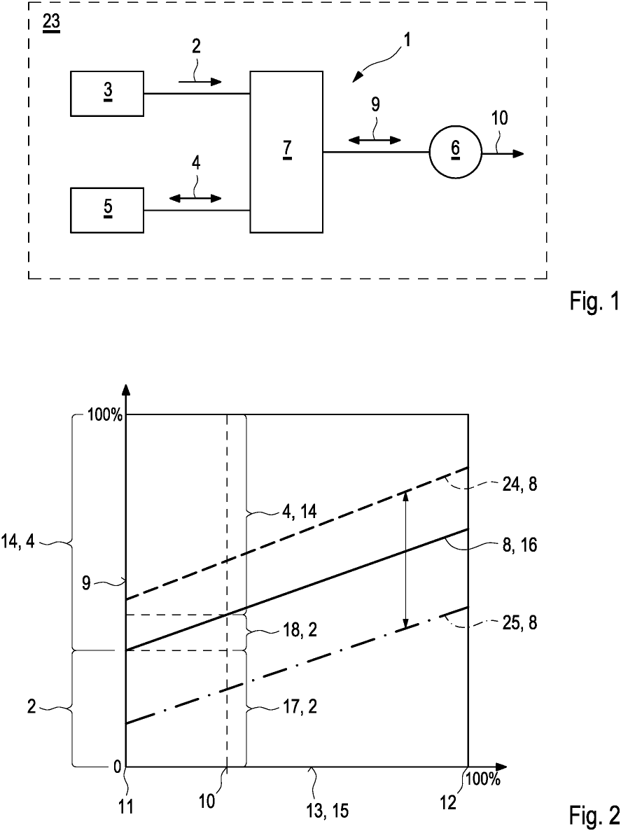

FIG. 1 shows a preferred exemplary embodiment of a fuel cell system designated as a whole with the reference number 1 according to a preferred exemplary embodiment. The fuel cell system 1 is exemplarily integrated in a motor vehicle 23 which is not illustrated and comprises a fuel cell 3 generating electric primary power 2, an electric rechargeable traction battery 5 providing electric secondary power 4, at least one traction drive 6 for providing a drive power 10 and a power management device 7, which provides the electric drive power 9 out of electric primary power 2 and/or electric secondary power 4 for providing the drive power 10 at the traction drive 6. The said components 3, 5, 6, 7 are each practically symbolised by a box, the said powers 2, 4, 9, 10 each by an arrow or double arrow indicating the main transport directions. The fuel cell 3, the traction battery 5 and the traction drive 6 are electrically coupled with the power management device 7, so that the latter can realise for example an open loop control and/or closed loop control in particular a profile control of the fuel cell 3 according to the method still to be explained in the following, the fuel cell 3, the traction battery 5 and the traction drive 6.

The diagram shown in FIG. 2 illustrates multiple characteristics for a method for operating the fuel cell system 1 from FIG. 1, wherein the fuel cell 3 is profile-controlled in particular by means of the power management device 7, which allows for example an appropriately efficient operation of the fuel cell 3 in an operating range that is energy efficient for the fuel cell 3, in particular a mean power range. According to the said method it is exemplarily provided that the fuel cell 3 is operated as a function of a fuel cell operating characteristic marked in the diagram with the reference number 8 and referred to as FCBK in the following, which is dependent on a drive power and/or on a charge status of the traction battery 5, i.e. provides electric primary power 2. Purely exemplarily, the FCBK 8 is realised by a straight line 16 which, with constant positive slope smaller than one and greater than zero and with a specified zero point offset relative to the abscissa, extends over a first power section 15 of a power range 13 of the traction drive 6 standardised to a value range between 0 and 1 (0 % and 100%) plotted on the abscissa. The FCBK 8 could also be realised by a linear function or a non-linear function or a series of interpolable support points and/or have a slope of zero, which here is not illustrated however. The said power range 13 of the traction drive 6 depicts the realisable drive powers 10 of the traction drive 6 between on the one hand a no-load power 11 (at 0%) of the traction drive 6 and on the other hand a full-load power 12 (at 100%) of the traction drive 6. In other words, the power range 13 thus represents the power capacity of the traction drive 6. Here, the first power section 15 extends over the entire power range 13, so that the fuel cell 3 thus profile-controlled over the entire power range 13 of the traction drive 6 by means of the FCBK 8 realised by the straight line 16. By way of this it is possible by means of the FCBK 8 to operate the fuel cell 3 in a profile-controlled manner so that within the first power section 15 electric primary power 2 is provided, which is composed of a constant basic amount of primary power 17 attributable to the zero point offset and of an additional amount of primary power 18 for growing drive powers 10 also growing proportionally according to the specified slope of the straight line 16. This is exemplarily entered into the diagram in FIG. 2 for a freely specified drive power 10. The said basic amount of primary power 17 describes a base of electric primary power 2, which in the traction mode is always generated and provided by the fuel cell 3 while the said additional amount of primary power 18 represents a variable amount of the electric primary power 2 dependent on the drive power and/or a charge status of the traction battery 5. Thus, electric primary powers 2 likewise growing constantly can always be provided within the first power section 15 for growing, requested electric drive powers 9 for generating drive powers 10 of the traction drive 6 to be provided.

Since the drive power 9, if applicable, is only covered at least proportionally by the electric primary power 2 generated and provided by the fuel cell 3 it is provided that a power differential 14 between the electric drive power 9 and the actually provided electric primary power 2 is provided by electric secondary power 4. By way of this, the electric drive power 9, at least in the case that the fuel cell 3 does not provide the entire requested electric drive power 9, is composed of electric primary power 2 and of electric secondary power 4.

In FIG. 2, two further FCBKs 8 are drawn in, wherein an FCBK 8 shifted upwards is marked with the reference number 24 (dashed line) and an FCBK 8 shifted downwards is marked with the reference number 25 (dash-dotted line). It is noticeable that although the slope of the straight line 16 of these two FCBKs 8, 24, 25 has remained constant, the zero point offset with the upper FCBK 8, 24 however is enlarged so that a correspondingly profile-controlled fuel cell 3 provides a greater constant base (electric basic amount of primary power 17) of electric primary power 2. The zero point offset of the lower FCBK 8, 25 by contrast is reduced so that a correspondingly profile-controlled fuel cell 3 provides a smaller, constant base (electric basic amount of primary power 17) of electric primary power 2. By way of this, a specified amount of electric primary power 2 that is independent of a drive power and thus, if applicable, an excess power for recharging the traction battery 5 can be generated and provided by means of the fuel cell 3, so that the traction battery 5 can be operated for example at a specified load status.

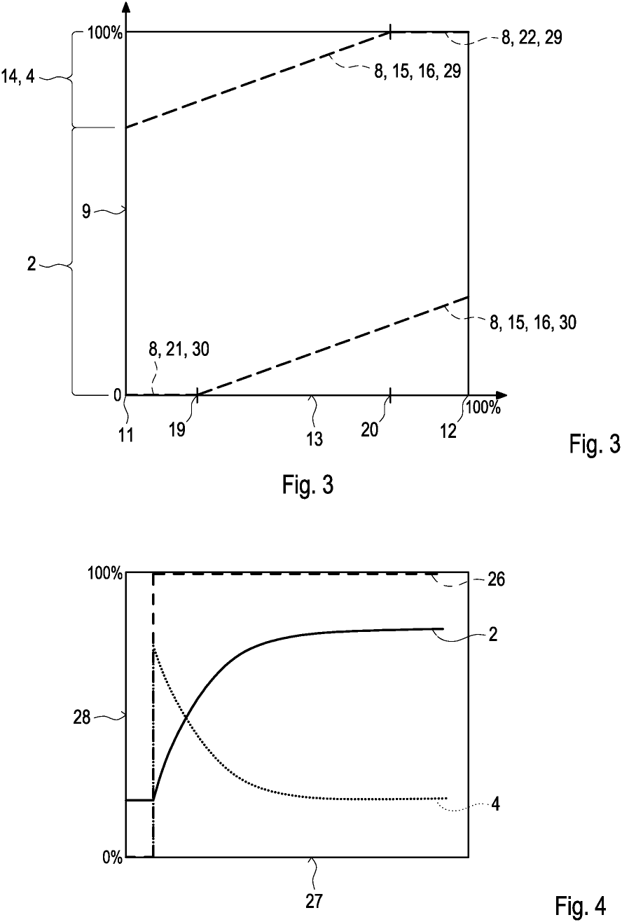

The diagram shown in FIG. 3 illustrates further FCBKs 8, 29, 30 which differ compared with the FCBKs 8, 24, 25 described in the diagram from FIG. 2. Accordingly, a further upper FCBK 8, which is marked with the additional reference number 29, comprises a first power section 15, in which the FCBK 8, 29 is realised by a straight line 16 with a constant slope and zero point offset, just like the FCBKs 8, 24, 25 from FIG. 2. However, the straight line 16 or the power section 15 of this FCBK 8, 29 merely extends partially over the power range 13, namely above the no-load power 11 and a second, specified power threshold 20, which exemplarily corresponds to 70% of the full-load power 12 of the traction drive 6. By contrast, a further lower FCBK 8, 30 is realised in a first power section 15 by a straight line 16 with constant slope and zero point offset, wherein this straight line 16 or this power section 15 also extends merely partially over the power range 13, namely above a first, specified power threshold value 19, which exemplarily corresponds to 30% of the full-load power 12 of the traction drive 6, as far as to the full-load power 12. Furthermore, the further lower FCBK 8, 30 exemplarily has a second power section 21 extending below the first power threshold value 19, within which the fuel cell 3 is profile-controlled so that no electric primary power 2 is generated. This means that the lower FCBK 8, 30 has the value zero in the second power section 21. The further upper FCBK 8, 29 also has a further power section designated third power section 22, wherein the same extends above the second power threshold value 20, within which the fuel cell 3 is profile-controlled so that a constant maximum amount of electric primary power 2 is generated and provided.

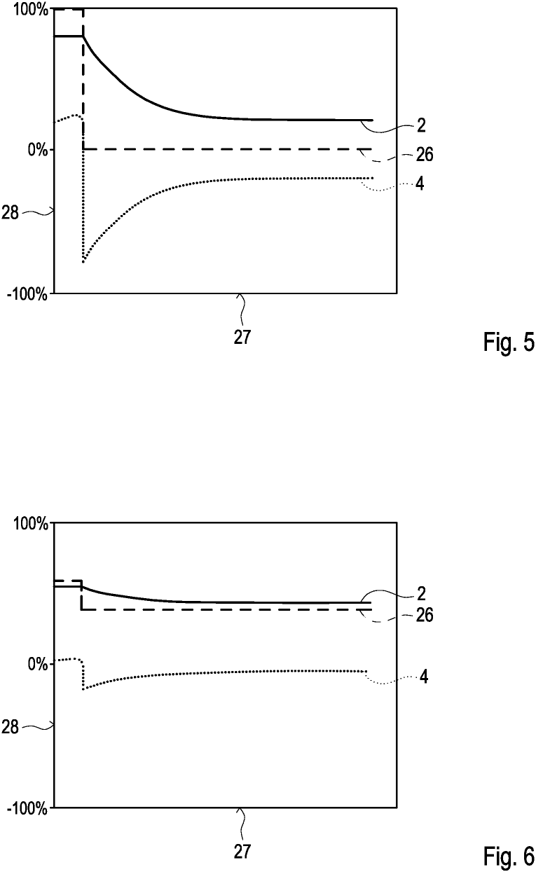

FIGS. 4 to 6 each show in a diagram the powers 28 provided in the fuel cell system 1 with different power curves 26 over the operating time 27. In FIG. 4, a power curve 26 in the form of a positive jump excitation is specified, a so-called kickdown, wherein the fuel cell 3 is profile-controlled so that dependent on a drive power a base of electric primary power 2 and an amount of electric secondary power 4 is available in order to cover the requested drive power 9. At the moment of the jump excitation, the provided electric drive power 9 is thus composed of approximately 30% of electric primary power 2 and of electric secondary power 4 for the remainder. The amount of electric primary power 2 generated and provided by the fuel cell increases over time, while the provided electric secondary power 4 decreases likewise. In FIG. 5, there is a power curve 26 in the form of a negative jump excitation, a so-called load drop, wherein the fuel cell 3 is profile-controlled so that initially a base of electric primary power 2 is generated which can be utilised for example for charging the traction battery 5. Over the time, the amount of electric primary power 2 generated and provided by the fuel cell 3 decreases to a base, approximately 30% of the requested electric drive power 9, which can likewise be utilised for recharging the traction battery. Finally, FIG. 6 shows a power curve 26 in the form of a negative load stroke, in the case of which the fuel cell 3 is profile-controlled so that an amount of electric primary power 2 is generated, which is initially utilised for charging the traction battery 5 and decreases over time.

1. A method for operating a fuel cell system including at least one fuel cell, at least one rechargeable traction battery, at least one traction drive, and a power management device, the power management device electrically coupled to the at least one fuel cell, the at least one traction battery, and the at least one traction drive, the method comprising:
providing electric primary power via the at least one fuel cell;
providing electric secondary power via the at least one traction battery; and
wherein the at least one fuel cellis profile-controlled.

2. The method for operating a fuel cell systemaccording to claim 1, wherein providing electric primary power includes profile-controlling the at least one fuel cell such thatthe at least one fuel cell provides electric primary poweras a function of a fuel cell operating characteristic (FCBK) that is dependent on at least one of a drive power and a charge status of the at least one traction battery.

3. The method for operating a fuel cell systemaccording to claim 2, further comprising providing a requested electric drive powerof the at least one traction drive, which is requested out of a power range extending from a no-load powerto a full-load powerof the at least one traction drive, wherein:
the provided electric drive power is at least proportionally provided by the provided electric primary power; and
a power differential between the requested electric drive power and the provided electric primary power is provided by electric secondary power such that the provided electric drive power is composed of electric primary power and electric secondary power.

4. The method for operating a fuel cell system according to claim 2, wherein:
the FCBK, in a first power sectionof a power range, is provided by at least one of a monotonously rising characteristic and a straight line with a constant, specifiable slope and with a specifiable zero point offset; and
the method further comprises controlling the at least one fuel cell in a profile-controlled manner within the first power section via the FCBK dependent on at least one of the drive power and a load status of the at least one traction battery such that the provided electric primary power is composed of (i) a constant basic amount of primary power of electric primary power specified by the zero point offset and (ii) an additional amount of primary power that for growing drive powers, grows according to the specified slope of the at least one of the monotonously rising characteristicand the straight line.

5. The method for operating a fuel cell system according to claim 4, wherein at least one of:
the first power section extends at least one of completelyand at least in portions over the power range; and/or
the first power section extends above a first specified power threshold value, which is adjusted variably over the entire first power section such thatthe first power threshold value corresponds to 30% of the full-load power;
the first power section extends below a second specified power threshold value, which is adjusted variably over the entire first power section such thatthe second power threshold value corresponds to 70% of the full-load power; and
the basic amount of primary power is one of zero and greater than zero.

6. The method for operating a fuel cell systemaccording to claim 4, wherein at least one of:
the specified basic amount of primary power is provided as a function of the charge status of the at least one traction battery;
the method further comprises achieving a target charge status of the at least one traction batteryraised with respect to the charge status of the at least one traction battery via increasing the specified basic amount of primary power; and
the method further comprises achieving a target charge status of the at least one traction batterylowered with respect to the charge status of the at least one traction battery via reducing the specified basic amount of primary power.

7. The method for operating a fuel cell system according to claim 2, wherein the at least one fuel cell is profile-controlled via the FCBK such that, when the at least one traction driveis operated with a no-load power, the at least one fuel cell provides a specified basic amount of primary power differing from zero.

8. The method for operating a fuel cell systemaccording to claim 7, wherein at least one of:
the specified basic amount of primary power is provided as a function of at least one of (i) the charge status of the at least one traction batteryand (ii) a differential between the charge status of the at least one traction batteryand a specified target charge status of the at least one traction battery;
the method further comprises achieving a target charge status of the at least one traction batteryraised with respect to a current charge status of the at least one traction battery via increasing the specified basic amount of primary power; and,
the method further comprises achieving a target charge status of the at least one traction batterylowered with respect to a current charge status of the at least one traction battery via reducing the specified basic amount of primary power.

9. The method for operating a fuel cell system according to claim 2, wherein:
the FCBK, in a power section of a power range, is provided with a value zero;
the power section extends below a power threshold value; and
the method further comprises profile-controlling the at least one fuel cell within the power section such thatthe at least one fuel cell does not provide any electric primary power.

10. The method for operating a fuel cell system according to claim 2, wherein:
the FCBK, in a power section of a power range, is provided with a constant maximum value;
the power section extends above a power threshold valve; and
the method further comprises profile-controlling the at least one fuel cell within the power section as a function of the FCBK such that the at least one fuel cell provides a maximally providable amount of electric primary power.

11. The method for operating a fuel cell system according to claim 2, further comprising operating the FCBK as a function of at least one of:
a target status of the at least one traction battery such that the electric primary power is provided dependent on a battery charge status;
an ambient temperature of the fuel cell system such that, dependent on a temperature, the electric primary power is provided;
a battery production age of the at least one traction battery such that, dependent on a battery status, the electric primary poweris provided;
a battery charge cycle number of the at least one traction battery such that, depending on the battery status, the electric primary power is provided;
a fuel cell coolant temperature of the at least one fuel cell such that, dependent on a fuel cell status, the electric primary power is provided; and
a battery coolant temperature of the at least one traction battery such that, dependent on the battery status, the electric primary power is provided.

12. The method for operating a fuel cell system according to claim 3, further comprising charging the at least one traction battery with at least a portion of the provided electric primary power when the requested electric drive power is smaller than the provided electric primary power.

13. A computer programme product, comprising commands which, when the programme is executed by a computer, cause the computer to carry out the method according to claim 1.

14. A fuel cell system integrated in a motor vehicle, the fuel cell system comprising:
at least one fuel cell configured to provide electric primary power;
at least one rechargeable traction battery configured to provide electric secondary power;
at least one traction drive; and
a power management device electrically coupled to the at least one fuel cell, the at least one traction battery, and the at least one traction drive; and
wherein the power management device is configured to carry out the method according to claim 1.

15. The method for operating a fuel cell system according to claim 2, further comprising achieving a preferred charge status of the at least one traction battery via at least one of adjusting, varying, and shifting the FCBK with respect to a slope of the FCBK as a function of the charge status of the at least one traction battery.

16. The method for operating a fuel cell system according to claim 4, wherein:
the first power section extends above a first specified power threshold value and below a second specified power threshold value;
the first power threshold value is adjusted variably over the entire first power section such that the first power threshold value corresponds to 30% of the full-load power; and
the second power threshold value is adjusted variably over the entire first power section such that the second power threshold value corresponds to 70% of the full-load power.

17. The method for operating a fuel cell system according to claim 16, wherein:
the FCBK, in a second power section of the power range, is provided with a value zero;
the second power section extends below the first power threshold value; and
the method further comprises profile-controlling the at least one fuel cell within the second power section such that the at least one fuel cell does not provide any electric primary power.

18. The method for operating a fuel cell system according to claim 17, wherein:
the FCBK, in a third power section of the power range, is provided with a constant maximum value;
the third power section extends above the second power threshold value; and
the method further comprises profile-controlling the at least one fuel cell within the third power section as a function of the FCBK such that the at least one fuel cell provides a maximally providable amount of electric primary power.

19. The method for operating a fuel cell system according to claim 9, wherein the power threshold value is at least one of (i) variably adjusted over the entire power section and (ii) provided as a function of the charge status of the at least one traction battery, such that the power threshold value corresponds to 10% to 40% of a full-load power of the at least one traction drive.

20. The method for operating a fuel cell system according to claim 10, wherein the power threshold value is at least one of (i) variably adjusted over the entire power section and (ii) provided as a function of the charge status of the at least one traction battery, such that the power threshold value corresponds to 60% to 100% of a full-load power of the at least one traction drive.
